(19) United States
(12) Patent Application Publication
(10) Pub. No.: US 2025/0074038 A1
(43) Pub. Date: Mar. 6, 2025

(54) ECOFRIENDLY ARTIFICIAL WOOD AND MANUFACTURING METHOD THEREFOR

(71) Applicant: Ani wood. Co., Ltd., Wonju-si, Gangwon-do (KR)

(72) Inventor: Cheol Hwan LIM, Wonju-si (KR)

(73) Assignee: Any wood. Co., Ltd., Wonju-si, Gangwon-do (KR)

(21) Appl. No.: 18/708,287

(22) PCT Filed: Dec. 13, 2021
(86) PCT No.: PCT/KR2021/018844

§ 371 Date: Jul. 16, 2024

(30) Foreign Application Priority Data
Nov. 10, 2021 (KR) 10-2021-0153822

(51) Int. Cl. B32B 27/08; B29C 48/00; B29C 48/21; B29K 27/06; B29K 509/00; B32B 3/04; B32B 3/30; B32B 27/20; B32B 27/30; B32B 27/32

(52) U.S. Cl. CPC B32B 27/08; B32B 3/04; B32B 3/30; B32B 27/20; B32B 27/302; B32B 27/304; B32B 27/308; B32B 27/32; B29C 48/002; B29C 48/21; B29K 2027/06; B29K 2509/00; B32B 2250/02; B32B 2250/24; B32B 2264/062; B32B 2264/1022; B32B 2264/108; B32B 2264/203; B32B 2270/00; B32B 2307/4026

(57) ABSTRACT

One aspect of the present invention provides a synthetic wood including a core portion and a skin portion disposed on at least a portion of a surface of the core portion, wherein the core portion includes a first polymer resin and a filler, the skin portion includes a second polymer resin and photocatalytic particles, a surface of the skin portion includes a wood pattern formed by an uneven structure including protrusions, and the content of the photocatalytic particles in the protrusions ranges from 5 to 30 wt %, and a method for manufacturing the synthetic wood.

### TECHNICAL FIELD

The present invention relates to an eco-friendly synthetic wood and a method for manufacturing the same.

### BACKGROUND ART

Air pollution caused by fumes, exhaust gases, and the like generated due to rapid industrial growth and economic development is increasing at a high rate. In recent years, addressing such environmental problems has become a common concern worldwide. South Korea is in an environment with harsher conditions than other countries due to the influx of large amounts of yellow dust and particulate matter originating from China and air pollutants generated domestically, and policies, such as the Green New Deal, for reducing particulate matter have been proposed but have not yielded any tangible results.

The development of building materials, air purifiers, eco-friendly materials, and the like that can reduce particulate matter in line with government policies is actively underway, and nowadays, research on technology that can reduce particulate matter by applying photocatalysts is being carried out. In particular, the demand for building materials using natural wood is increasing, but it is difficult to meet this demand with natural wood alone, and there are problems in that natural wood is easily deformed due to moisture and easily develops mold.

In response to this, synthetic wood (or artificial wood) with a texture and appearance similar to natural wood is being developed. Synthetic wood is being used in various facilities such as urban parks, national parks, walking trails, and historical trails. Synthetic wood is being installed in a wide range from urban areas to forests, and it is necessary to use eco-friendly materials in consideration of human accessibility and greening purposes.

In general, synthetic wood can be manufactured by extrusion or injection molding of a mixture of fibers such as wood flour and thermoplastic resins that are easy to process. Since the fibers and thermoplastic resins are difficult to mix and disperse evenly, there is a limit to increasing the mechanical properties of the synthetic wood manufactured therefrom to a certain level or higher.

In relation to this, according to Korean Patent Registration Nos. 10-2146090, 10-2070681, etc., by forming a base layer including chemically surface-treated wood flour, the compatibility between the wood flour and resin and the durability of the synthetic wood manufactured therefrom can be improved, and by introducing a photocatalyst to a surface layer, eco-friendliness can be imparted to the synthetic wood. However, the color of a pigment applied to the surface layer is arbitrarily lightened by white titanium dioxide applied as the photocatalyst, and such color interference occurring between the pigment and titanium dioxide makes it difficult to realize the color and texture of natural wood on the surface of the synthetic wood.

Meanwhile, even according to the related art described above, there is a limitation in that it is impossible to control the region-specific concentration gradient of photocatalytic particles in the surface layer, for example, the distribution in the thickness (height) direction or the distribution in protrusions and grooves that constitute the unevenness. In particular, since photocatalytic particles settled at the bottom of the surface layer cannot be easily exposed to ambient light, that is, since the ambient light cannot penetrate to the settled photocatalytic particles, it is difficult for the settled photocatalytic particles to have a required level of catalytic activity.

### DISCLOSURE

### Technical Problem

The present invention is for addressing the above-described problems of the related art and is directed to providing an eco-friendly synthetic wood and a method for manufacturing the same capable of implementing and improving photocatalytic activity and appearance properties of synthetic wood in a balanced manner by precisely controlling region-specific concentration gradient of photocatalytic particles included in a surface region of the synthetic wood.

### Technical Solution

One aspect of the present invention provides synthetic wood including a core portion and a skin portion disposed on at least a portion of a surface of the core portion, wherein the core portion includes a first polymer resin and a filler, the skin portion includes a second polymer resin and photocatalytic particles, a surface of the skin portion includes a wood pattern formed by an uneven structure including protrusions, and a content of the photocatalytic particles in the protrusions ranges from 5 to 30 wt %.

In one embodiment, a content of the first polymer resin in the core portion may range from 20 to 70 wt %.

In one embodiment, the core portion may further include fibrous powder, and a content of the fibrous powder in the core portion may range from 30 to 70 wt %. In one embodiment, the core portion may further include one additive selected from the group consisting of an impact modifier, a processing aid, a lubricant, a stabilizer, a plasticizer, a foaming agent, a pigment, and a combination of two or more thereof.

In one embodiment, a content of the photocatalytic particles in the skin portion may range from 0.1 to 5 wt %.

In one embodiment, in the skin portion, a ratio B/A of a content B of the photocatalytic particles in the protrusions to a content A of the photocatalytic particles in portions excluding the protrusions may range from 2 to 20.

In one embodiment, the first and second polymer resins may each include polyvinyl chloride (PVC).

In one embodiment, the photocatalytic particles may include titanium dioxide (TiO₂).

In one embodiment, the TiO₂ may have an anatase phase.

Another aspect of the present invention provides a method for manufacturing the synthetic wood, the method including: (a) forming the core portion by discharging a first composition including the first polymer resin and the filler through a main extruder; (b) forming the skin portion by discharging a second composition including the second polymer resin and the photocatalytic particles onto at least a portion of the surface of the core portion through an auxiliary extruder; and (c) forming the wood pattern formed by the uneven structure including the protrusions on the surface of the skin portion by pressing the surface of the skin portion with a patterning roll preheated to a temperature ranging from 400 to 500° C., and moving at least some of the photocatalytic particles included in the skin portion to the protrusions.

### Advantageous Effects

A synthetic wood according to one aspect of the present invention includes a core portion and a skin portion disposed on at least a portion of a surface of the core portion, wherein a surface of the skin portion includes a wood pattern formed by an uneven structure including protrusions, and the content of photocatalytic particles in the protrusions is adjusted to range from 5 to 30 wt %. In this way, the photocatalytic activity and appearance properties of the synthetic wood can be implemented and improved in a balanced manner.

Also, a method for manufacturing the synthetic wood according to another aspect of the present invention includes, in forming the wood pattern on the surface of the skin portion, pressing the surface of the skin portion with a patterning roll preheated to a predetermined temperature and moving at least some of the photocatalytic particles included in the skin portion to the protrusions. In this way, the above-described effects can be implemented.

It should be understood that the effects of the present invention are not limited to the above-described effects, and include all effects that can be inferred from the configuration of the invention described in the detailed description or claims of the present invention.

### DESCRIPTION OF DRAWINGS

FIG. 1 is a cross-sectional view of synthetic wood according to one embodiment of the present invention.

FIG. 2 is an enlarged view of region A of FIG. 1.

FIG. 3 illustrates a method for manufacturing the synthetic wood according to one embodiment of the present invention.

FIG. 4 illustrates extruders according to one embodiment of the present invention.

### MODES OF THE INVENTION

Hereinafter, the present invention will be described with reference to the accompanying drawings. However, the present invention may be implemented in various different forms and thus is not limited to the embodiments described herein. Also, in the drawings, in order to clearly describe the present invention, parts irrelevant to the description are omitted, and like parts are denoted by like reference numerals throughout the specification.

Throughout the specification, when a certain part is described as being “connected” to another part, this not only includes a case in which the part is “directly connected” to the other part, but also includes a case in which the part is “indirectly connected” to the other part with another member disposed therebetween. Also, when a certain part is described as “including” a certain component, unless specifically described otherwise, this means that the part may further include other components instead of excluding other components.

Hereinafter, embodiments of the present invention will be described in detail with reference to the accompanying drawings.

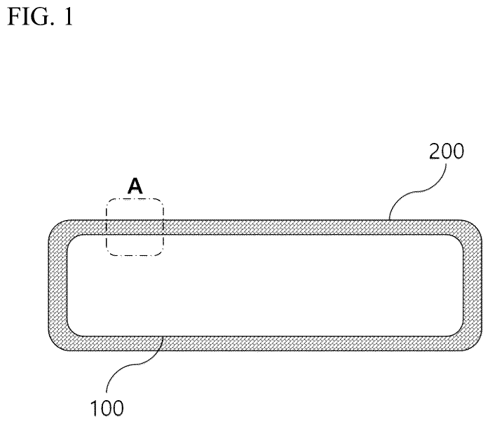

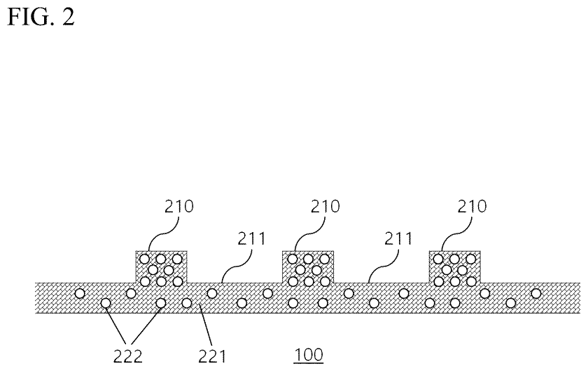

FIG. 1 is a cross-sectional view of synthetic wood according to one embodiment of the present invention, and FIG. 2 is an enlarged view of region A of FIG. 1.

Referring to FIGS. 1 and 2, synthetic wood according to one embodiment of the present invention may include a core portion 100 and a skin portion 200 disposed on at least a portion of a surface of the core portion 100. The term “core portion 100” used in the present specification refers to an inner region of synthetic wood having a plate shape, and “skin portion 200” refers to at least a portion of the surface of the core portion 100, preferably, an outer region of the synthetic wood that is disposed throughout the surface of the core portion 100 and exposed to the outside. The core portion 100 and the skin portion 200 may be integrally formed by a method which will be described below, but since compositions for forming the core portion 100 and the skin portion 200 are different, and the compositions are added through separate devices, the core portion 100 and the skin portion 200 may be independent configurations divided by a predetermined interface. Although the interface does not include a separate material and/or member for coupling the core portion 100 and the skin portion 200, since the interface does not include any pores and/or voids that disrupt the coupling between the core portion 100 and the skin portion 200, the core portion 100 and the skin portion 200 may be firmly coupled to each other.

The core portion 100 may include a first polymer resin and a filler. The first polymer resin may be a thermoplastic resin. For example, the thermoplastic resin may include one polyolefin selected from the group consisting of polyethylene, polypropylene, polybutylene, polymethylpentene, ethylene vinyl acetate, ethylene butyl acrylate, ethylene ethyl acrylate, and a combination or copolymer of two or more thereof, an acrylonitrile-butadiene-styrene (ABS) copolymer, polyvinyl chloride (PVC), or a combination thereof, and preferably, may include PVC, but is not limited thereto.

The filler may contribute to the durability and mechanical properties of the core portion 100. For example, the filler may include one particulate, spherical, and/or plate-shaped filler selected from the group consisting of hard coal, calcium carbonate, silica, talc, vermiculite, mica, aluminum hydroxide, aluminum oxide, barium sulfate, and a combination of two or more thereof, and preferably, may include vermiculite, more preferably, expanded vermiculite, but is not limited thereto. The expanded vermiculite has a very low specific gravity of about 0.15 and thus is advantageous in reducing the weight of the core portion 100 and the synthetic wood including the same and can also obtain an effect of releasing negative ions and far-infrared rays.

Also, the filler may further include fibrous fillers. For example, the fibrous fillers may be one selected from the group consisting of glass fibers, carbon fibers, cellulose fibers, engineering plastic fibers, ceramic fibers, and a combination of two or more thereof, and preferably, may be glass fibers and/or cellulose fibers, but are not limited thereto.

The fibrous fillers may allow the particulate, spherical, and/or plate-shaped filler to be fixed in an evenly dispersed state in the core portion 100, and the fibrous fillers adjacent to each other among the fibrous fillers dispersed in the first polymer resin constituting a continuous phase in the core portion 100 may form at least one intersection point and/or contact point and contribute to improving the strength and durability of the core portion 100.

The content of the first polymer resin in the core portion 100 may range from 20 to 70 wt %, preferably, 20 to 50 wt %. When the content of the first polymer resin in the core portion 100 is less than 20 wt %, the dispersibility of the filler and/or other particulate materials included in the core portion 100 may be degraded, and when the content of the first polymer resin in the core portion 100 exceeds 70 wt %, the durability and mechanical properties of the core portion 100 and the synthetic wood including the same may be degraded.

The core portion 100 may further include fibrous powder. The fibrous powder may be made by drying wood, waste wood, agricultural products, waste agricultural products, and the like by hand and then pulverizing the dried wood, waste wood, agricultural products, waste agricultural products, and the like to form powder having a particle size of about 30 to 120 mesh. The content of the fibrous powder in the core portion 100 may range from 30 to 70 wt %. When the content of the fibrous powder in the core portion 100 is less than 30 wt %, the durability and mechanical properties of the core portion 100 and the synthetic wood including the same may be degraded, and when the content of the fibrous powder in the core portion 100 exceeds 70 wt %, the dispersibility of the filler, fibrous powder, and/or other particulate materials included in the core portion 100 may be degraded.

The core portion 100 may further include one additive selected from the group consisting of an impact modifier, a processing aid, a lubricant, a stabilizer, a plasticizer, a foaming agent, a pigment, and a combination of two or more thereof.

The impact modifier may impart predetermined elasticity to the core portion 100 to contribute to the impact resistance of the core portion 100 and the synthetic wood including the same. The impact modifier may be a thermoplastic resin, preferably, a thermoplastic elastomer or a rubber resin, but is not limited thereto.

For example, the impact modifier may be an ABS copolymer, but is not limited thereto.

The processing aid may contribute to the processability and workability of the first polymer resin. Specifically, when a composition including the first polymer resin and the filler is foamed and extruded to form the core portion 100, the processing aid may accelerate melting of the first polymer resin and other resin components, impart predetermined viscoelasticity, and uniformly maintain the foamed and extruded cell structure of the core portion 100. For example, the processing aid may be a methyl methacrylate-ethyl acrylate-butyl acrylate copolymer, but is not limited thereto.

During processing of the first polymer resin, the lubricant serves to reduce friction between polymer chains (internal lubricant) or reduce friction between the first polymer resin and a processing machine (external lubricant). In particular, when a lubricant is not added during processing of PVC, local friction may occur, and transformation such as pigmentation may occur due to an increase in the temperature of the molded product that is caused by an abnormal thermal deformation temperature of the resin, and friction between the resin and the processing machine may increase, which may not only cause thermal deformation of the resin due to adhesion of the resin, but also cause a significant decrease in the ease of maintenance and repair of the processing machine.

For example, the internal lubricant may be calcium stearate, barium stearate, magnesium stearate, fatty alcohol, or the like, preferably, calcium stearate that can also serve as a thermal stabilizer, but is not limited thereto.

For example, the external lubricant may be polyethylene wax, oxidized polyethylene wax, paraffin wax, paraffin oil, amide wax, a metal salt of fatty acid, zinc stearate, lead stearate, or the like, preferably, a combination of polyethylene wax and a metal salt of fatty acid that can also serve as a thermal stabilizer, but is not limited thereto.

Also, the lubricant may further include an ester lubricant such as glyceryl monostearate, glyceryl monooleate, or butyl stearate, which has functions of both the external and internal lubricants.

The plasticizer penetrates between the first polymer resin and polymers constituting other resin components, thereby weakening the forces between the polymers and improving the mobility of polymer chains. Also, the plasticizer may lower the glass transition temperature of the polymers and impart flexibility thereto. In particular, in PVC, the flexibility can be easily adjusted just by adjusting the amount of plasticizer added thereto.

For example, the plasticizer may be one selected from the group consisting of: phthalic acid esters such as dioctyl phthalate and dibutyl phthalate; adipic acid/sebacic acid esters such as dioctyl adipate and dioctyl sebacate; paraffins such as paraffin oil, paraffin wax, and chlorinated paraffin; polyesters; oils such as process oil, epoxidized oil, and epoxidized vegetable oil; phosphate esters; and a combination of two or more thereof, preferably, oils that can also serve as a thermal stabilizer, but is not limited thereto.

For example, the foaming agent may be one selected from the group consisting of one or more selected from the group consisting of azodicarbonamide, dinitrosopentamethyltetramine, azobisisobutyronitrile, and p-toluenesulfonyl hydrazide, heat-expandable microcapsules in which a liquid, low-boiling-point hydrocarbon is injected into a thermoplastic polymer shell, and a combination of two or more thereof, preferably, a combination of azodicarbonamide and heat-expandable microcapsules, but is not limited thereto.

When the heat-expandable microcapsules are heated, as the polymer shell softens, and the liquid hydrocarbon injected thereinto is converted into gas, the heat-expandable microcapsules may expand to a volume that is 50 to 100 times its initial volume. The heat-expandable microcapsules may reduce the weight of the core portion 100 and the synthetic wood including the same by decreasing moisture content and specific gravity while forming independent foam.

The pigment may be carbon black, iron oxide (Fe₂O₃), or a combination thereof, preferably, a mixture of carbon black and Fe₂O₃ mixed at a predetermined ratio, and may impart various colors to the core portion 100.

For example, the composition of the core portion 100 may include 20 to 70 wt % of the first polymer resin, 30 to 70 wt % of the fibrous powder, 1 to 10 wt % of the impact modifier, 1 to 10 wt % of the filler, 1 to 5 wt % of the processing aid, 0.1 to 5 wt % of the lubricant (also serves as a thermal stabilizer), 0.1 to 5 wt % of the plasticizer (also serves as a thermal stabilizer), 0.1 to 5 wt % of the foaming agent, and 0.1 to 5 wt % of the pigment, but is not limited thereto.

The skin portion 200 may include a second polymer resin 221 and photocatalytic particles 222. The second polymer resin 221 may be a thermoplastic resin. For example, the thermoplastic resin may include one polyolefin selected from the group consisting of polyethylene, polypropylene, polybutylene, polymethylpentene, ethylene vinyl acetate, ethylene butyl acrylate, ethylene ethyl acrylate, and a combination or copolymer of two or more thereof, an ABS copolymer, PVC, or a combination thereof, and preferably, may include PVC, but is not limited thereto.

The photocatalytic particles 222 may include titanium oxide (TiO₂), and preferably, may include anatase phase TiO₂. Since the anatase phase TiO₂ has better photocatalytic activity than rutile phase TiO₂ and has various whiteness indices and/or transparency values according to an average particle diameter and thus has excellent compatibility with the pigment, it is possible to implement a predetermined wood pattern on a surface of the skin portion 200 more elegantly.

The surface of the skin portion 200 may include a wood pattern formed by an uneven structure including regular or irregular protrusions 210 that correspond to a solid wood pattern to implement the wood pattern. The wood pattern may simulate the texture or pattern observed on a surface and/or a cross-section of the actual natural wood. The uneven structure may include predetermined grooves 211 formed to correspond to the protrusions 210. The wood pattern may be implemented by a wood pattern formed by the solidness and texture due to the uneven structure and a slight color difference between the protrusions 210 and the grooves 211. The color difference may be adjusted according to content of TiO₂ included in the protrusions 210 and the grooves 211. Specifically, since TiO₂ is naturally white, the color difference becomes more prominent as a difference in the TiO₂ content between the protrusions 210 and the grooves 211 increases. However, since the sharpness of the wood pattern may decrease or the wood pattern may look unnatural when the color difference is insufficient or excessive, it is necessary to appropriately adjust the color difference.

Meanwhile, in the skin portion 200, the photocatalytic particles 222 may be dispersed in a discontinuous phase in a continuous phase matrix formed of the second polymer resin 221. When the skin portion 200 is extrusion-molded while the photocatalytic particles 222 are not evenly dispersed, for example, are settled at the bottom of the skin portion 200, since the settled photocatalytic particles 222 cannot be easily exposed to ambient light, that is, since the ambient light cannot penetrate to the settled photocatalytic particles 222, it is difficult for the settled photocatalytic particles 222 to have a required level of catalytic activity.

Therefore, there is a need to move and concentrate the photocatalytic particles 222 to the top of the skin portion 200 to increase the area and frequency of light exposure. The area and frequency of light exposure may be increased by moving and concentrating at least some of the photocatalytic particles 222 to the protrusions 210 in the skin portion 200. Specifically, while the photocatalytic particles 222 located at lower portions of the grooves 211 are exposed to light through one surface constituting the grooves 211, the photocatalytic particles 222 located at edges of lower portions of the protrusions 210 may be exposed to light through two or more surfaces constituting the protrusions 210. That is, the photocatalytic activity of the synthetic wood can be significantly improved by moving and concentrating the photocatalytic particles 222 to the top of the skin portion 200 and moving and concentrating at least some of the photocatalytic particles 222 to the protrusions 210.

The content of the photocatalytic particles 222 in the protrusions 210 may range from 5 to 30 wt %. When the content of the photocatalytic particles 222 in the protrusions 210 is less than 5 wt %, it is difficult to implement a required level of photocatalytic activity, and the sharpness of the wood pattern may decrease due to an insufficient color difference between the protrusions 210 and the grooves 211, and when the content of the photocatalytic particles 222 in the protrusions 210 exceeds 30 wt %, photocatalytic activity in the grooves 211 may decrease, and the wood pattern may look unnatural due to an excessive color difference between the protrusions 210 and the grooves 211.

The content of the photocatalytic particles 222 in the skin portion 200, specifically, the average content of the photocatalytic particles 222 throughout the entire area of the skin portion 200, may range from 0.1 to 5 wt %. When the content of the photocatalytic particles 222 in the skin portion 200 is less than 0.1 wt %, it is difficult to implement a required level of photocatalytic activity, and when the content of the photocatalytic particles 222 in the skin portion 200 exceeds 5 wt %, it is difficult to appropriately move and concentrate the photocatalytic particles 222 to the protrusions 210.

In the skin portion 200, a ratio B/A of content B of the photocatalytic particles 222 in the protrusions 210 to content A of the photocatalytic particles 222 in portions excluding the protrusions 210 may range from 2 to 20. When the ratio B/A is less than 2, it is difficult to implement a required level of photocatalytic activity, and the sharpness of the wood pattern may decrease due to an insufficient color difference between the protrusions 210 and the grooves 211, and when the ratio B/A exceeds 20, photocatalytic activity in the grooves 211 may decrease, and the wood pattern may look unnatural due to an excessive color difference between the protrusions 210 and the grooves 211.

The skin portion 200 may further include one additive selected from the group consisting of a filler, a lubricant, a stabilizer, a plasticizer, a pigment, and a combination of two or more thereof. The types, effects, and the like of each of the additives listed above are the same as described above.

For example, the composition of the skin portion 200 may include 70 to 95 wt % of the second polymer resin 221, 0.1 to 5 wt % of the photocatalytic particles 222, 1 to 10 wt % of the filler, 0.1 to 5 wt % of the plasticizer (also serves as a thermal stabilizer), 0.1 to 5 wt % of the lubricant (also serves as a thermal stabilizer), and 0.1 to 5 wt % of the pigment, but is not limited thereto.

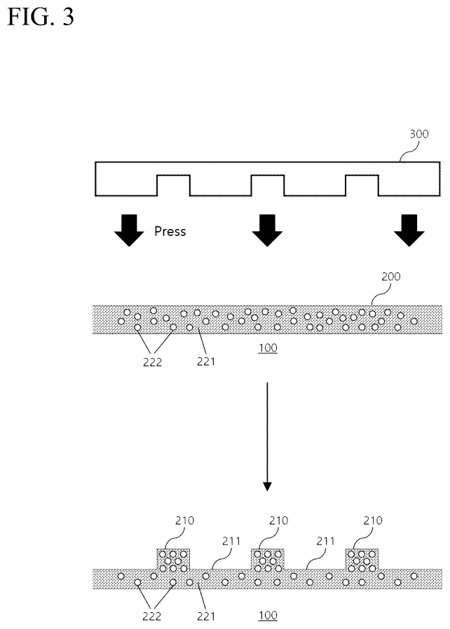

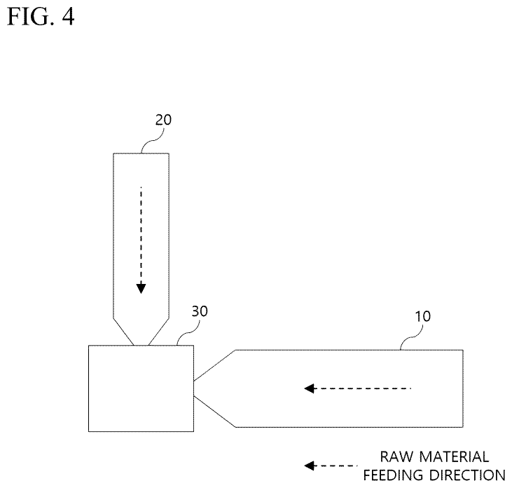

FIG. 3 illustrates a method for manufacturing the synthetic wood according to one embodiment of the present invention, and FIG. 4 illustrates extruders according to one embodiment of the present invention.

Referring to FIGS. 3 and 4, a method for manufacturing the synthetic wood according to one embodiment of the present invention may include: (a) forming the core portion 100 by discharging a first composition including the first polymer resin and the filler through a main extruder 10; (b) forming the skin portion 200 by discharging a second composition including the second polymer resin 221 and the photocatalytic particles 222 onto at least a portion of the surface of the core portion 100 through an auxiliary extruder 20; and (c) forming the wood pattern formed by the uneven structure including the protrusions 210 on the surface of the skin portion 200 by pressing the surface of the skin portion 200 with a patterning roll 300 preheated to a temperature ranging from 400 to 500° C., and moving at least some of the photocatalytic particles 222 included in the skin portion 200 to the protrusions 210.

In step (a), the core portion 100 may be formed by discharging the first composition including the first polymer resin and the filler through the main extruder 10. The first composition may be added to a hopper of the main extruder 10 and fed and melted while being heated to a predetermined temperature, and then the core portion 100 may be extrusion-molded using a dice 30 at a front end of the main extruder 10. The main extruder 10 may be a single-screw extruder or a twin-screw extruder, preferably, a twin-screw extruder that can improve the processability and dispersibility of the first composition, but is not limited thereto. The first composition may further include fibrous powder and other additives, and each of the components included in the first composition and the content, effects, and the like of each component are the same as described above.

In step (b), the skin portion 200 may be formed by discharging the second composition including the second polymer resin 221 and the photocatalytic particles 222 onto at least a portion of the surface of the core portion 100, preferably, the entire surface of the core portion 100, through the auxiliary extruder 20. A cavity in which the core portion 100 is extruded may be provided in the dice 30 of the main extruder 10, and a front end of the auxiliary extruder 20 may be connected to the cavity. Therefore, the skin portion 200 may be extruded while being stacked on the surface of the core portion 100 by, while extruding the core portion 100 through the dice 30 of the main extruder 10, adding the second composition to the auxiliary extruder 20 and discharging the melted second composition onto the surface of the core portion 100 passing through the dice 30. The auxiliary extruder 20 may be a single-screw extruder or a twin-screw extruder, preferably, a twin-screw extruder that can improve the processability and dispersibility of the second composition, but is not limited thereto. The second composition may further include a filler and other additives, and each of the components included in the second composition and the content, effects, and the like of each component are the same as described above.

In step (c), the wood pattern formed by the uneven structure including the protrusions 210 may be formed on the surface of the skin portion 200 by pressing the surface of the skin portion 200 with the patterning roll 300 preheated to a temperature ranging from 400 to 500° C., and at least some of the photocatalytic particles 222 included in the skin portion 200 may be moved to the protrusions 210.

Typically, a process of aging and cooling the core portion 100 and the skin portion 200 is further included between steps (b) and (c), and since this step is performed while the distribution of the photocatalytic particles 222 included in the skin portion 200 is not appropriately adjusted, it is difficult for the surface of the skin portion 200 to secure a required level of photocatalytic activity.

In this regard, while forming the wood pattern formed by the uneven structure including the protrusions 210 on the surface of the skin portion 200 by pressing the surface of the skin portion 200 with the patterning roll 300 preheated to a temperature ranging from 400 to 500° C., at least some of the photocatalytic particles 222 included in the skin portion 200 may be moved to the protrusions 210 to adjust the content of the photocatalytic particles 222 in the protrusions 210 to the above-described range of 5 to 30 wt %. When the preheating temperature of the patterning roll 300 is lower than 400° C., it is difficult to implement a required level of photocatalytic activity in the protrusions 210, and the sharpness of the wood pattern may decrease due to an insufficient color difference between the protrusions 210 and the grooves 211, and when the preheating temperature of the patterning roll 300 exceeds 500° C., photocatalytic activity in the grooves 211 may decrease, and the wood pattern may look unnatural due to an excessive color difference between the protrusions 210 and the grooves 211.

Hereinafter, examples of the present invention will be described in detail.

### Example 1

55 wt % of wood flour, 30 wt % of PVC resin, 4 wt % of ABS resin, 4 wt % of expanded vermiculite, 3 wt % of methyl methacrylate-ethyl acrylate-butyl acrylate copolymer, 0.2 wt % of calcium stearate, 2 wt % of polyethylene wax, 1 wt % of plasticizer, 0.2 wt % of glyceryl monostearate, 0.2 wt % of heat-expandable microcapsules, 0.2 wt % of azodicarbonamide, and 0.2 wt % of carbon black were added to a mixer, heated to a temperature of about 130° C., and kneaded to produce a gel-like raw material, and the gel-like raw material was cooled to a temperature of about 60° C. to obtain a powdery raw material.

40 wt % of PVC resin, 10 wt % of polyethylene resin, 25 wt % of anatase phase TiO₂, and 25 wt % of Fe₂O₃ pigment were melted and kneaded to produce a masterbatch, and 10 parts by weight of the masterbatch and 90 parts by weight of a matrix including 90 wt % of PVC resin, 8 wt % of expanded vermiculite, and 2 wt % of oil were melted, kneaded, and extruded to obtain a pellet-like raw material.

The powdery raw material was input into a main extruder (twin-screw extruder) and discharged through a dice to extrusion-mold a core portion, the pellet-like raw material was input into an auxiliary extruder connected to the dice, and a skin portion was extrusion-molded while being stacked on a surface of the core portion to obtain a semi-finished product.

The semi-finished product was aged and cooled after being transferred to a vacuum calibrator connected to a rear end of the main extruder, and then a surface of the skin portion was pressed with a pair of patterning rolls preheated to 400° C. to obtain synthetic wood in which a wood pattern is formed on the surface of the skin portion.

### Example 2

Synthetic wood was obtained in the same manner as in Example 1, except that the surface of the skin portion was pressed with a pair of patterning rolls preheated to 430° C.

### Example 3

Synthetic wood was obtained in the same manner as in Example 1, except that the surface of the skin portion was pressed with a pair of patterning rolls preheated to 450° C.

### Example 4

Synthetic wood was obtained in the same manner as in Example 1, except that the surface of the skin portion was pressed with a pair of patterning rolls preheated to 480° C.

### Example 5

Synthetic wood was obtained in the same manner as in Example 1, except that the surface of the skin portion was pressed with a pair of patterning rolls preheated to 500° C.

### Example 6

Synthetic wood was obtained in the same manner as in Example 3, except that the masterbatch was produced by melting and kneading 40 wt % of PVC resin, 5 wt % of polyethylene resin, 30 wt % of anatase phase TiO₂, and 25 wt % of Fe₂O₃ pigment.

### Example 7

Synthetic wood was obtained in the same manner as in Example 3, except that the masterbatch was produced by melting and kneading 40 wt % of PVC resin, 5 wt % of polyethylene resin, 40 wt % of anatase phase TiO₂, and 15 wt % of Fe₂O₃ pigment.

### Example 8

Synthetic wood was obtained in the same manner as in Example 3, except that the masterbatch was produced by melting and kneading 40 wt % of PVC resin, 50 wt % of anatase phase TiO₂, and 10 wt % of Fe₂O₃ pigment.

### Comparative Example 1

Synthetic wood was obtained in the same manner as in Example 1, except that the surface of the skin portion was pressed with a pair of patterning rolls preheated to 390° C.

### Comparative Example 2

Synthetic wood was obtained in the same manner as in Example 1, except that the surface of the skin portion was pressed with a pair of patterning rolls preheated to 510° C.

### Comparative Example 3

Synthetic wood was obtained in the same manner as in Example 1, except that the masterbatch was produced by melting and kneading 35 wt % of PVC resin, 60 wt % of anatase phase TiO₂, and 5 wt % of Fe₂O₃ pigment.

### Experimental Example 1: Composition of Wood Pattern

The compositions of wood patterns of synthetic wood samples obtained from the Examples and the Comparative Examples were evaluated as follows. The content of TiO₂ in powder compositions obtained by polishing protrusions constituting the wood pattern formed on the surface of the skin portion of the synthetic wood and portions excluding the protrusions was quantitatively analyzed, and results thereof are shown in Table 1 below.

TABLE 1

| | Content | Content of TiO₂ | |
|---|---|---|---|
| | of TiO₂ | (excluding | |
| | (protrusions, | protrusions, | |
| Classification | wt %, B) | wt %, A) | B/A |
| Example 1 | 5.1 | 2.2 | 2.3 |
| Example 2 | 12.7 | 2.0 | 6.5 |
| Example 3 | 15.1 | 1.4 | 10.5 |
| Example 4 | 17.9 | 1.3 | 14.1 |
| Example 5 | 20.4 | 1.1 | 19.2 |
| Example 6 | 24.1 | 1.5 | 16.3 |
| Example 7 | 28.3 | 1.5 | 18.6 |
| Example 8 | 29.8 | 1.5 | 19.5 |
| Comparative | 4.4 | 2.4 | 1.8 |
| Example 1 | | | |
| Comparative | 35.7 | 0.9 | 38.1 |
| Example 2 | | | |
| Comparative | 38.1 | 0.8 | 45.6 |
| Example 3 | | | |

### Experimental Example 2: Appearance Properties

The appearance properties of the synthetic wood samples obtained from the Examples and the Comparative Examples were evaluated as follows. Color differences between the protrusions constituting the wood pattern formed on the surface of the skin portion of the synthetic wood and the portions excluding the protrusions were observed by visual inspection to evaluate the sharpness of the wood pattern, and results thereof are shown in Table 2 below (⊙: Excellent, O: Good, X: Poor).

TABLE 2

| Classification | Appearance Property |
|---|---|
| Example 1 | ◯ |
| Example 2 | ◯ |
| Example 3 | ◯ |
| Example 4 | ⊙ |
| Example 5 | ⊙ |
| Example 6 | ⊙ |
| Example 7 | ⊙ |
| Example 8 | ⊙ |
| Comparative Example 1 | X |
| Comparative Example 2 | X |
| Comparative Example 3 | X |

### Experimental Example 3: Photocatalytic Activity

The photocatalytic activity of the synthetic wood samples obtained from the Examples and the Comparative Examples was evaluated as follows. 5 mL of methylene blue solution was dropped onto the protrusions constituting the wood pattern formed on the surface of the skin portion of the synthetic wood and the portions excluding the protrusions, the protrusions and the portions excluding the protrusions were exposed to sunlight for five hours, and changes in color of the methylene blue solution were observed and classified into the case in which the methylene blue solution became completely colorless (O), a case in which the color change was slight (O), and the case in which there was no color change (X), and results thereof are shown in Table 3 below.

TABLE 3

| | | Portions excluding |
|---|---|---|
| Classification | Protrusions | protrusions |
| Example 1 | ⊙ | ⊙ |
| Example 2 | ⊙ | ⊙ |
| Example 3 | ⊙ | ⊙ |
| Example 4 | ⊙ | ⊙ |
| Example 5 | ⊙ | ◯ |
| Example 6 | ⊙ | ⊙ |
| Example 7 | ⊙ | ⊙ |
| Example 8 | ⊙ | ◯ |
| Comparative Example 1 | X | ◯ |
| Comparative Example 2 | ⊙ | X |
| Comparative Example 3 | ⊙ | X |

The above description of the present invention is only for illustrative purposes, and those of ordinary skill in the art to which the present invention pertains should understand that the present invention may be easily modified into other specific forms without changing the technical spirit or essential features of the present invention. Therefore, the above-described embodiments should be understood as illustrative, instead of limiting, in all aspects. For example, each component described as a single type may be implemented in a distributed manner, and likewise, components described as being distributed may be implemented in a combined form.

The scope of the present invention is shown by the claims below, and all changes or modifications derived from the meaning and scope of the claims and their equivalent concepts should be construed as falling within the scope of the present invention.

<Description of reference numerals>

| | |
|---|---|
| 100: core portion | 200: skin portion |
| 210: protrusion | 211: groove |
| 221: second polymer resin | 222: photocatalytic |
| 300: patterning roll | 10: main extruder |
| 20: auxiliary extruder | 30: dice |

1. A synthetic wood comprising:
a core portion; and
a skin portion disposed on at least a portion of a surface of the core portion,
wherein the core portion includes a first polymer resin and a filler,
the skin portion includes a second polymer resin and photocatalytic particles,
a surface of the skin portion includes a wood pattern formed by an uneven structure including protrusions, and
a content of the photocatalytic particles in the protrusions ranges from 5 to 30 wt %.

2. The synthetic wood of claim 1, wherein a content of the first polymer resin in the core portion ranges from 20 to 70 wt %.

3. The synthetic wood of claim 2, wherein:
the core portion further includes fibrous powder; and
a content of the fibrous powder in the core portion ranges from 30 to 70 wt %.

4. The synthetic wood of claim 1, wherein the core portion further includes one additive selected from the group consisting of an impact modifier, a processing aid, a lubricant, a stabilizer, a plasticizer, a foaming agent, a pigment, and a combination of two or more thereof.

5. The synthetic wood of claim 1, wherein a content of the photocatalytic particles in the skin portion ranges from 0.1 to 5 wt %.

6. The synthetic wood of claim 5, wherein, in the skin portion, a ratio (B/A) of a content (B) of the photocatalytic particles in the protrusions to a content (A) of the photocatalytic particles in portions excluding the protrusions ranges from 2 to 20.

7. The synthetic wood of claim 1, wherein the first and second polymer resins each include polyvinyl chloride (PVC).

8. The synthetic wood of claim 1, wherein the photocatalytic particles include titanium dioxide (TiO₂).

9. The synthetic wood of claim 8, wherein the TiO₂ has an anatase phase.

10. A method for manufacturing the synthetic wood of claim 1, the method comprising:
(a) forming the core portion by discharging a first composition including the first polymer resin and the filler through a main extruder;
(b) forming the skin portion by discharging a second composition including the second polymer resin and the photocatalytic particles onto at least a portion of the surface of the core portion through an auxiliary extruder; and
(c) forming the wood pattern formed by the uneven structure including the protrusions on the surface of the skin portion by pressing the surface of the skin portion with a patterning roll preheated to a temperature ranging from 400 to 500° C., and moving at least some of the photocatalytic particles included in the skin portion to the protrusions.
